(19) United States
(12) Patent Application Publication
(10) Pub. No.: US 2007/0120028 A1
(43) Pub. Date: May 31, 2007

(54) Article holder for a ladder

(76) Inventor: William T. Kane, Copake, NY (US)

Correspondence Address: LITMAN LAW OFFICES, LTD., P.O. BOX 15035, CRYSTAL CITY STATION, ARLINGTON, VA, 22215, US

(21) Appl. No.: 11/543,095

(22) Filed: Oct. 5, 2006

Related U.S. Application Data
(60) Provisional application No. 60/740,626, filed on Nov. 30, 2005.

(51) Int. Cl. E04G 3/00; E06C 7/14; E04G 1/00; E06C 5/32

(52) U.S. Cl. 248/210; 182/129

(57) ABSTRACT

The article holder for a ladder is formed of a flexible sheet of material (e.g., coated fabric, flexible plastic, etc.) and includes two opposed ladder attachment edges with a generally central fold line therebetween and parallel thereto. At least one pocket opening is provided through the sheet, with the pocket depending from the sheet rather than being coplanar therewith. The opening(s) may be provided with closures or left open. Preferably, at least one magnet is secured to the sheet, opposite the depending pocket(s), in order to hold hand tools, nails, screws, and other articles formed of ferrous metal. Various attachments may be used to secure the device to the ladder, e.g., wire hooks, tie strings or cords, mating fabric hook and loop fastener material (e.g., Velcro®), buttons and/or snaps, etc., but plastic locking ties (e.g., Ty-Raps®) are preferred for ease of use, economy, security, and ease of removal when desired.

### CROSS-REFERENCE TO RELATED APPLICATION

This application claims the benefit of U.S. Provisional Patent Application Ser. No. 60/740,626, filed Nov. 30, 2005.

### BACKGROUND OF THE INVENTION

1. Field of the Invention

The present invention relates generally to pouches, compartments, and similar devices for holding various articles. More specifically, the present invention comprises an article holder adapted for removable attachment to a conventional ladder for holding and securing various small articles therein and tools thereon.

2. Description of the Related Art

Folding ladders and the like are nearly universally used to enable workers to access heights otherwise above their reach. Conventional stepladders typically include a pair of brace legs, which fold from beneath the top step, with a folding accessory shelf or platform generally pivotally mounted between the two brace legs and essentially level with the second step from the top of the ladder. A pair of extension arms catches beneath the second step to hold the shelf level when the ladder is deployed. Such accessory shelves are often used to support a paint can, small power or hand tools, parts, etc., as needed, in order to preclude need for the worker to climb up and down the ladder for such articles.

However, the typical accessory shelf is rather limited in its utility. Such shelves generally have no sidewalls to restrain articles placed thereon, and the lateral slats forming the shelf are generally spaced apart from one another. This precludes the placement of smaller articles (e.g., screws, nails, wire nuts, etc.) thereon, with any hope that they will remain on the shelf for long. Moreover, such shelves are prone to tipping when little weight is resting thereon. Such shelves are nearly universally formed of the same materials as the ladder, i.e. wood or aluminum. This precludes the use of magnetic attraction to retain any ferrous metal articles on the shelf.

Accordingly, various article holders for attachment to ladders and the like have been developed in the past. Oftentimes such devices have been provided with pockets, but the pockets are coplanar with the primary sheet of material of which the device is constructed, to facilitate construction of the device. This makes it difficult to access the interior of the pocket if the article holder is oriented horizontally, and the mouth of the pocket is often oriented downwardly when the device is folded, thus allowing articles within the pocket to spill. Other devices have been constructed with magnets to hold ferrous metal tools and parts, but the magnets are nearly universally enclosed within permanently closed pockets. These pockets do nothing to contain tools or parts. Yet another category of ladder-attached article holders comprises devices having rigid, three-dimensional structures. These devices cannot be folded when the ladder is folded, and must be removed from the ladder before folding the ladder.

Thus, an article holder for a ladder solving the aforementioned problems is desired.

### SUMMARY OF THE INVENTION

The article holder for a ladder is formed of a flexible sheet of material (e.g., coated fabric, flexible plastic, etc.) and includes a ladder step attachment edge and an opposite accessory shelf pivot crossmember attachment edge, with a generally central fold line therebetween and parallel thereto. At least one pocket opening is provided through the surface of the sheet, with the pocket depending from the sheet rather than being coplanar therewith. Two pockets are preferably provided, and the opening(s) may be provided with closure means or left open, as desired. Preferably, at least one magnet is secured to the surface of the sheet, opposite the depending pocket(s). This enables the device to hold hand tools, nails, screws, and other articles formed of ferrous metal. Various means may be used to attach the device to the ladder, e.g., wire hooks, tie strings or cords, mating fabric hook and loop fastener material (e.g., Velcro®), buttons and/or snaps, etc., but plastic locking ties (e.g., Ty-Raps®) are preferred for ease of use, economy, security, and ease of removal when desired.

These and other features of the present invention will become readily apparent upon further review of the following specification and drawings.

### BRIEF DESCRIPTION OF THE DRAWINGS

FIG. 1 is an environmental, perspective view of an article holder for a ladder according to the present invention, shown installed upon a conventional ladder.

FIG. 2 is a detailed perspective view of the article holder according to the present invention, showing further details and alternative features thereof.

FIG. 3 is a side elevation view in section of the article holder according to the present invention, showing further details, the folded configuration being shown in broken lines.

Similar reference characters denote corresponding features consistently throughout the attached drawings.

### DETAILED DESCRIPTION OF THE PREFERRED EMBODIMENTS

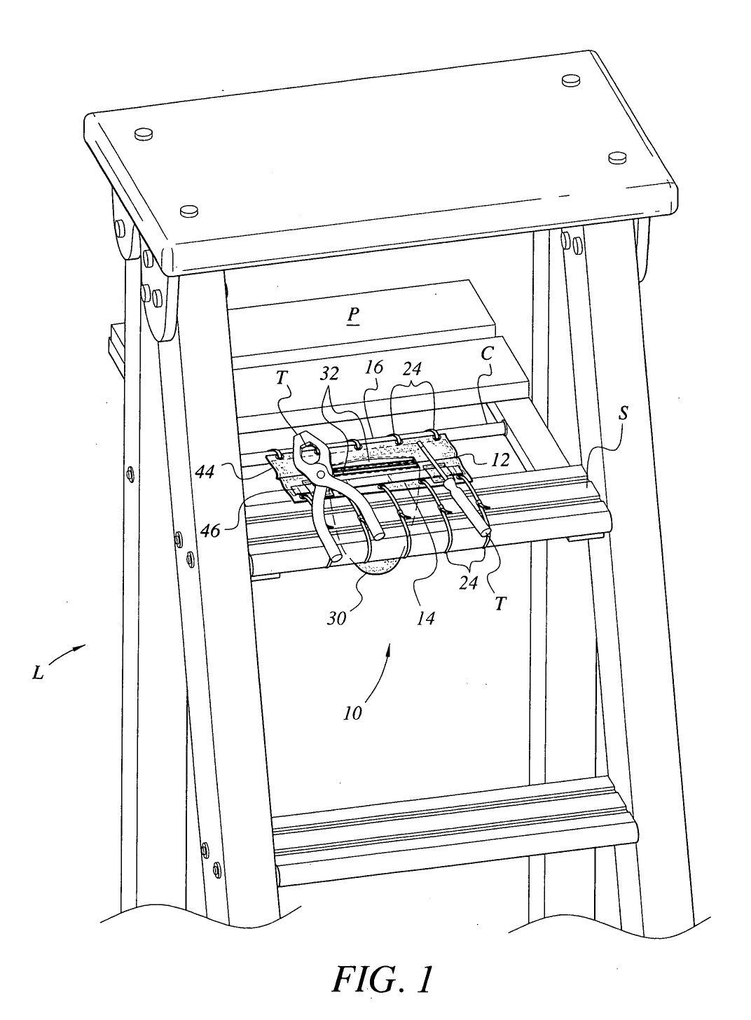

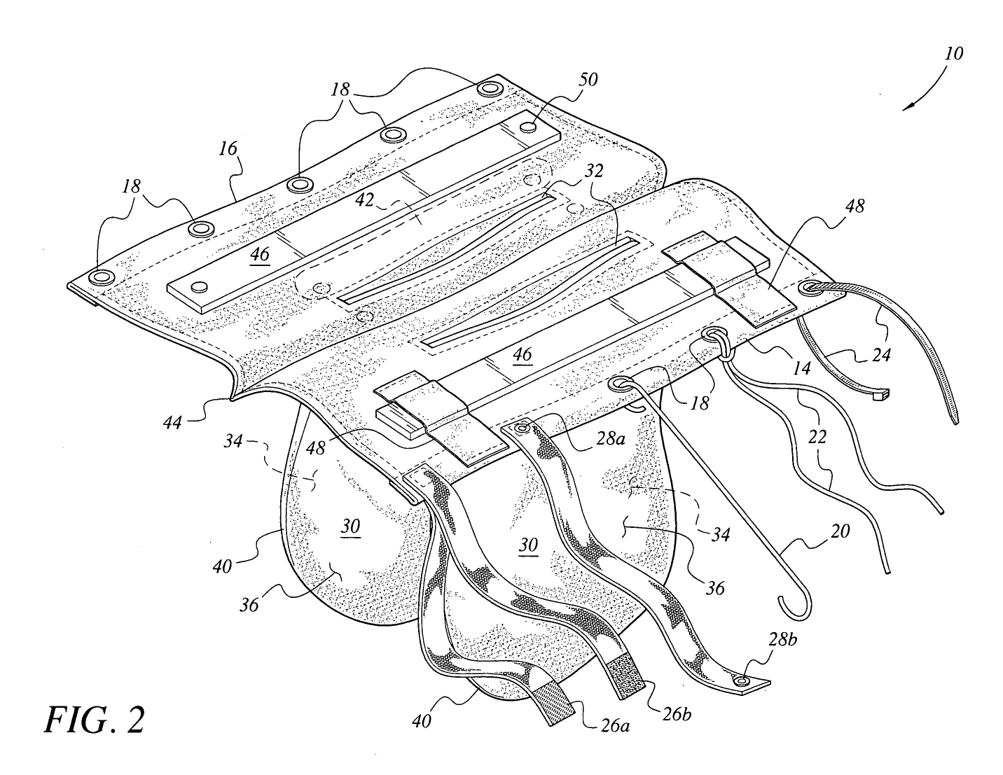

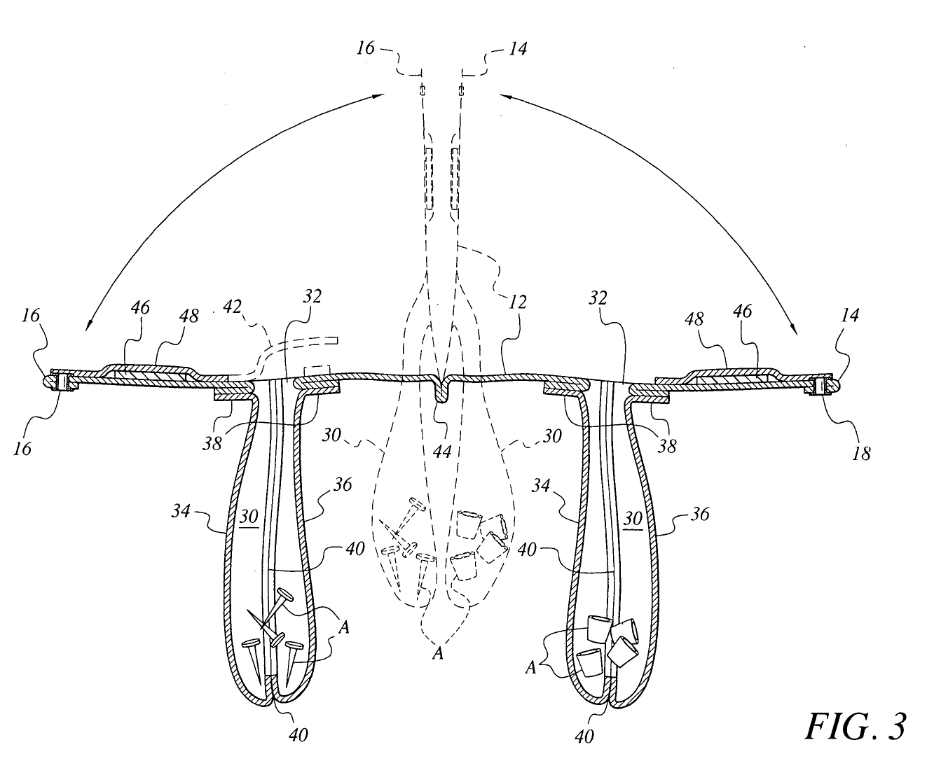

The present invention comprises several embodiments of an article holder for removable attachment to a ladder, for holding small power and hand tools and equipment, parts, fasteners, and other articles for a worker standing on the ladder. FIG. 1 of the drawings provides an environmental perspective view of the article holder 10 installed upon an opened ladder L, with FIG. 2 providing an enlarged view with further details and FIG. 3 clearly showing the depending pockets of the device.

The article holder 10 essentially comprises a generally rectangular, flexible, planar article support sheet 12, which is secured across the upper portion of the ladder L. The article support sheet 12 may be formed of a number of suitable flexible materials, e.g., plasticized fabrics, fabric mesh, heavy gauge natural and synthetic fabrics, and/or leather, as desired. The support sheet 12 has a first or ladder step attachment edge 14 and a parallel opposite second or ladder shelf pivot crossmember attachment edge 16. The two edges 14 and 16 are specifically adapted for respective attachment to the penultimate step S and to the crossmember C to which the ladder shelf or platform P is pivotally mounted. The edges 14 and 16 may include a generally evenly spaced series of grommets 18, through which various attachment devices may be secured.

In FIG. 2, various alternative attachments are shown installed through the grommets 18 of the first edge 14, e.g., a wire hook 20 and tie string or cord 22. However, the use of plastic locking ties 24 (e.g., Ty-Raps®) is preferred for ease of use, economy, security, and ease of removal when desired. A series of such plastic locking ties 24 is shown in FIG. 1, securing the first edge 14 of the device to the penultimate step S of the ladder L. Alternatively, other attachment means may be used, e.g., mating hook and loop fabric straps 26a and 26b and mating snap fastener straps 28a and 28b. It will be understood that the showing of a series of different types of fasteners on a single article holder 10 in FIG. 2 is for illustrative purposes in a single drawing and that the device 10 would normally be equipped with only a single type of attachment.

The article holder 10 includes at least one (and preferably two) pocket(s) 30 therein, with the two pockets 30 preferably located generally symmetrically on the device, as shown by the pocket openings 32 formed through the article support sheet 12. Each pocket 30 is formed of a first panel 34 and an opposite second panel 36, with their upper edges 38 (shown in FIG. 3) secured to the article support sheet 12 adjacent the edges of the pocket openings 32. The remaining edges 40 of the two panels 34, 36 are stitched or otherwise secured together to form a closed pocket 30, with the exception of the pocket opening 32. The two panels 34, 36 of which each pocket 30 is formed result in the pocket structures depending from the plane of the article support sheet 12, particularly if they are formed of relatively flexible material and/or they contain a reasonable mass therein. This assures that the pockets 30 will remain substantially vertically oriented at all times, regardless of the configuration and orientation of the ladder L to which the article holder 10 is attached. The pocket(s) 30 are preferably constructed with rounded bottom portions, as shown in FIGS. 1 and 2, in order to avoid tight corners that may gather or collect small articles therein. Each of the pockets 30 may include an openable closure 42 (e.g., a flap, etc., as shown in broken lines in FIGS. 2 and 3) for securing over the pocket opening 32, if so desired, but the depending configuration of the pockets 30 precludes any great need for such closure.

The flexible support sheet 12 further includes a generally central fold line 44 extending thereacross between the two edges 14 and 16 and substantially parallel thereto. This fold line 44 may be formed across the material of the support sheet 12 by stitching the two sides together along a narrow seam, or otherwise forming such a fold line. The purpose of the fold line 44 is to facilitate the folding together of the preferably relatively heavy material of which the support sheet 12 is made as the ladder L is folded.

The pocket(s) 30 perform well for holding relatively small articles A (e.g., nails or screws, wire nuts, etc., as shown in the cross section view of FIG. 3.) However, some additional security is required for larger tools that will not fit within the pocket(s) 30. Accordingly, one or more magnets 46 may be installed upon the upper surface (i.e., opposite the pockets 30) of the article support sheet 12, for attracting and retaining tools T (e.g., pliers, screwdriver, etc. as shown in FIG. 1) formed of ferrous metals. The magnet(s) 46 may in turn be secured to the support sheet 12 by magnet holders comprising one or more straps 48 which extend across a portion of the support sheet 12, or rivets 50 extending through the magnet 46 and underlying support sheet 12, or some other means, as desired. The straps 48 allow the magnets 46 (e.g. elongate bar magnets, as shown, or other configuration) to be removed from the device 10 if such removal is necessary, e.g., when placing or holding magnetic media on the support sheet 12.

In conclusion, the article holder for use with ladders provides a most convenient means for workers using ladders to retain tools, small parts, and other articles close at hand without concern that such tools and articles will fall from the ladder. The device may be secured to the ladder on a semipermanent basis by means of plastic locking ties, or various other means as desired. The unique configuration of the device allows it to fold readily about its centerline when the ladder is folded, thereby reducing bulk in the interstice between the legs of the ladder when folded. The depending pockets of the device assure that their mouths or openings will always remain above the interiors of the pockets, thereby assuring that parts and other articles will remain securely within the pockets, regardless of the orientation of the ladder. Accordingly, the article holder for ladders will prove to be a most popular accessory for most anyone who has occasion to perform some work while standing upon a ladder.

It is to be understood that the present invention is not limited to the embodiments described above, but encompasses any and all embodiments within the scope of the following claims.

I claim:

1. An article holder for a ladder, comprising:
A flexible, planar article support sheet having a ladder step attachment edge and a ladder shelf pivot crossmember attachment edge opposite the ladder step attachment edge, the attachment edges being substantially parallel;
a plurality of ladder attachments extending from at least one of the attachment edges; and
at least one pocket first panel and at least one pocket second panel joined together to form at least one pocket depending from the article support sheet, the article support sheet having a pocket opening defined therein providing access to the pocket.

2. The article holder according to claim 1, further including a generally central fold line extending across said article support sheet between the ladder step attachment edge and the ladder shelf pivot crossmember attachment edge, the central fold line being parallel to the attachment edges.

3. The article holder for a ladder according to claim 1, further including:
at least one magnet holder disposed upon said article support sheet; and
at least one magnet disposed in the magnet holder.

4. The article holder for a ladder according to claim 1, wherein said ladder attachments are selected from the group consisting of flexible plastic locking ties, mating hook and loop fabric straps, wire hooks, tie strings and cords, and mating snap fasteners.

5. The article holder for a ladder according to claim 1, further including an openable closure disposed over the pocket opening.

6. The article holder for a ladder according to claim 1, wherein said article support sheet is formed of materials selected from the group consisting of plasticized fabrics, fabric mesh, heavy gauge natural and synthetic fabrics, and leather.

7. An article holder for a ladder, comprising:
A flexible, planar article support sheet having mutually opposed parallel attachment edges and a generally centrally disposed fold line between the attachment edges and parallel thereto, the support sheet having at least one pocket opening defined therein;
a plurality of ladder attachments extending from at least one of the attachment edges; and
at least one pocket attached to the at least one pocket opening, the pocket depending from the article support sheet and extending substantially normal thereto when the sheet is extended between opposing legs of an open stepladder.

8. The article holder for a ladder according to claim 7, wherein said at least one pocket comprises a pocket first panel and a pocket second panel joined together to form the pocket, the first and second panels being attached to said sheet on opposing sides of the pocket opening.

9. The article holder for a ladder according to claim 7, further including:
at least one magnet holder disposed upon said article support sheet; and
at least one magnet disposed in the magnet holder.

10. The article holder for a ladder according to claim 7, wherein said ladder attachments are selected from the group consisting of flexible plastic locking ties, mating hook and loop fabric straps, wire hooks, tie strings and cords, and mating snap fasteners.

11. The article holder for a ladder according to claim 7, further including an openable closure disposed over the pocket opening.

12. The article holder for a ladder according to claim 7, wherein said article support sheet is formed of materials selected from the group consisting of plasticized fabrics, fabric mesh, heavy gauge natural and synthetic fabrics, and leather.

13. An article holder for a ladder, comprising:
A flexible, planar article support sheet having mutually opposed parallel attachment edges;
a plurality of ladder attachments extending from at least one of the attachment edges;
at least one pocket depending from the article support sheet, the article sheet having a pocket opening defined therein providing access to the pocket;
at least one magnet holder disposed upon the article support sheet; and
at least one magnet disposed in the magnet holder.

14. The article holder for a ladder according to claim 13, wherein said at least one pocket comprises a pocket first panel and a pocket second panel joined together to form said pocket, the first and second panels being attached to said sheet on opposite sides of the pocket opening.

15. The article holder for a ladder according to claim 13, further including a generally central fold line extending across said article support sheet between the attachment edges and parallel to the attachment edges.

16. The article holder for a ladder according to claim 13, wherein said ladder attachments are selected from the group consisting of flexible plastic locking ties, mating hook and loop fabric straps, wire hooks, tie strings and cords, and mating snap fasteners.

17. The article holder for a ladder according to claim 13, further including an openable closure disposed over the at least one pocket opening.

18. The article holder for a ladder according to claim 13, wherein said article support sheet is formed of materials selected from the group consisting of plasticized fabrics, fabric mesh, heavy gauge natural and synthetic fabrics, and leather.
